(19) United States
(12) Patent Application Publication
(10) Pub. No.: US 2012/0266855 A1
(43) Pub. Date: Oct. 25, 2012

(54) Grill with Means for Adjusting the Elevation of a Grid

(76) Inventor: Kiosky CHUNG, Taichung City (TW)

(21) Appl. No.: 13/092,953

(22) Filed: Apr. 24, 2011

(51) Int. Cl. A47J 37/07

(52) U.S. Cl. 126/25 A

(57) ABSTRACT

A grill includes a fire pan, two support members, a lever and a panel. Each of the support members includes a middle section, two arms extending from the middle section, two journals each extending from a related one of the arms, a crank extending from one of the journals, and a loop secured to the crank. The journals are inserted through the fire pan. The lever is pivotally connected to the fire pan and formed with a bent end inserted through the loops of the support members and a rectilinear end maneuverable by a user to pivot the lever to adjust the elevation of the middle sections of the support members. The panel extends parallel to the journals of the support members and includes a slot defined therein and recesses in communication with the slot. The lever is inserted through and movable along the slot and can be inserted in a selected one of the recesses.

### BACKGROUND OF INVENTION

1. Field of Invention

The present invention relates to a grill and, more particularly, to a grill with reliable, smooth means for adjusting the elevation of a grid relative to a fire pan.

2. Related Prior Art

A barbecue party is an outdoor activity in which friends can have a good time. In a barbecue party, there is of course a need for a grill, simple or complicated in structure.

Disclosed in U.S. Pat. No. 3,048,162 is a conventional grill with means for adjusting the elevation of grids 9 and 10 relative to a fire pan. The adjustment means includes two support members 20 pivotally supported on the fire pan and a keeper plate 27 secured to the fire pan. Each of the support members 20 includes a middle section, front and rear arms 21 extending from the middle section at an angle, a rear journal 22 extending from the rear arm 21 at an angle, a front journal 23 extending from the front arm 21 at an angle, and a crank 24 extending from the front journal 23 at an angle. The keeper plate 27 includes two slots 26. Notches 28 are defined in a rear edge of each of the slots 26. In assembly, each of the support members 20 is pivotally supported on the fire pan as the rear journal 22 is inserted through and rotationally supported on a rear wall 3 of the fire pan while the front journal 23 is inserted through and rotationally supported on a front wall 2 of the fire pan. The crank 24 of each of the support members 20 is inserted through a related one of the slots 26. In use, the grills 9 and 10 are supported on the middle sections of the support members 20. The crank 24 of each of the support members 20 can be retained in a selected one of the notches 28 of a related one of the slots 26 so that the middle section of the support member 20 can be located in a selected one of several vertical positions relative to the fire pan. That is, the elevation of the grids 9 and 10 is adjustable. There is however no connection of the support members 20 to each other. Hence, the middle sections of the support members 20 may be in different vertical positions, i.e., the grids 9 and 10 may be tilted and fuel may be dropped from the grids 9 and 10.

Referring to FIGS. 1 and 2, there is shown another conventional grill 80 with means for adjusting the elevation of a grid relative to a fire pan. The adjustment means includes two support members 81 and a control unit 90. Each of the support members 81 includes a middle section, front and rear arms extending from the middle section at an angle, a rear journal extending from the rear arm at an angle, a front journal extending from the front arm at an angle, a crank extending from the front journal at an angle, a front section 82 extending from the crank at an angle, and a loop 83 secured to the front section 82. The control unit 90 includes a panel attached to the fire pan, a slot 91 defined in the panel, recesses 92 defined in the panel, a lever 93 pivotally connected to the fire pan and inserted through the loops 83, a grip 95 located around the lever 93, and a spring 94 located around the lever 93 and in the grip 95. The spring 94 includes an end in contact with an enlarged end of the lever 93 and an opposite end in contact with an annular rib formed on an internal side of the grip 95. By holding the grip 95 and pivoting the lever 93, the vertical positions of the middle sections of the support members 81 are adjusted synchronously. That is, the elevation of a grid supported on the middle sections of the support members 81 is adjusted while the grid is retained horizontal. Biased by the spring 94, the grip 95 can be located in a selected one of the recesses 92 so that the grid is located in a selected one of several horizontal positions corresponding to the recesses 92. The lever 93 is however too short to render smooth the operation of the adjustment means. Moreover, it takes quite some time to insert the lever 93 in the spring 94 and the grip 95.

The present invention is therefore intended to obviate or at least alleviate the problems encountered in prior art.

### SUMMARY OF INVENTION

It is the primary objective of the present invention to provide a grill with reliable, smooth means for adjusting the elevation of a grid relative to a fire pan.

To achieve the foregoing objective, the grill includes a fire pan, two support members, a lever and a panel. Each of the support members includes a middle section, two arms extending from the middle section, two journals each extending from a related one of the arms, a crank extending from one of the journals, and a loop secured to the crank. The journals are inserted through the fire pan. The lever is pivotally connected to the fire pan and formed with a bent end inserted through the loops of the support members and a rectilinear end maneuverable by a user to pivot the lever to adjust the elevation of the middle sections of the support members. The panel extends parallel to the journals of the support members and includes a slot defined therein and recesses in communication with the slot. The lever is inserted through and movable along the slot and can be inserted in a selected one of the recesses.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a partial, side view of a conventional grill;

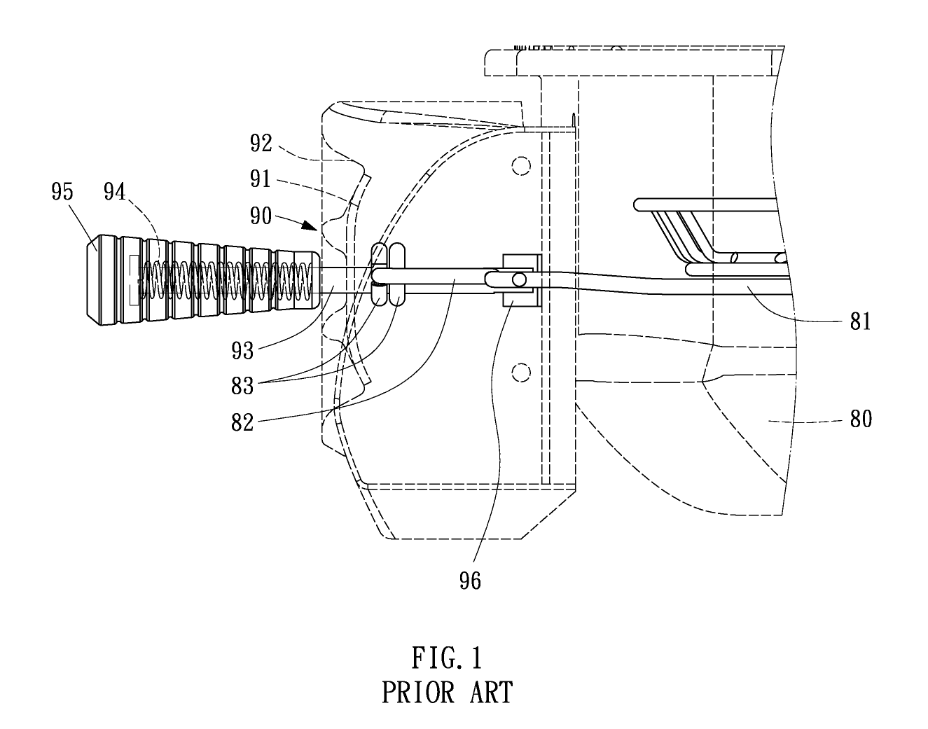

FIG. 2 is a partial, side view of the conventional grill in another position than shown in FIG. 1;

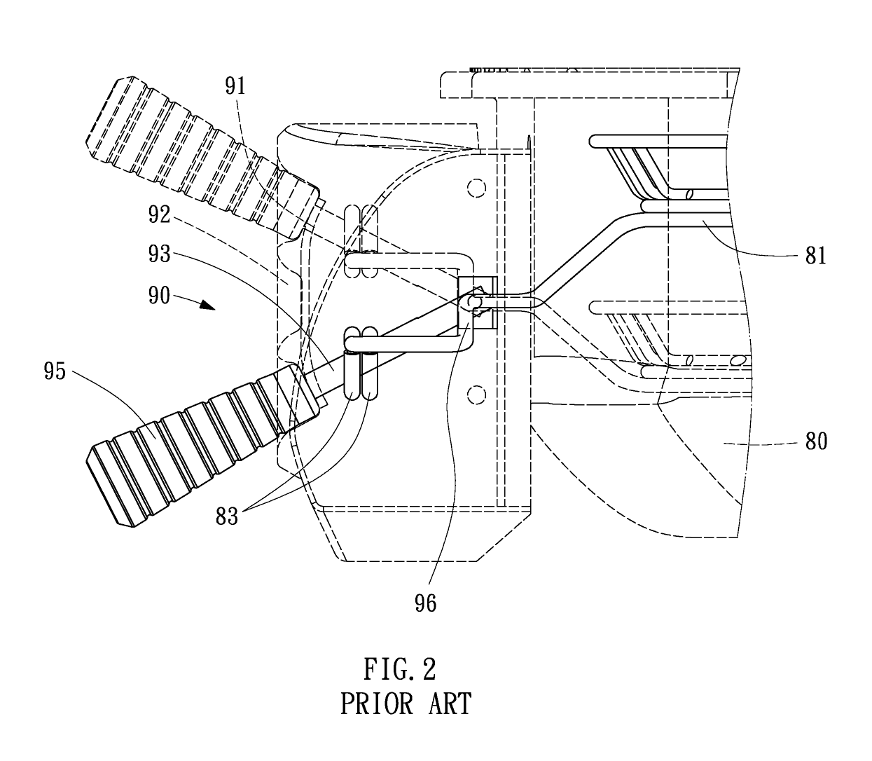

FIG. 3 is an exploded view of a grill according to the preferred embodiment of the present invention;

FIG. 4 is a top view of the grill shown in FIG. 3;

FIG. 5 is an exploded view of adjustment means used in the grill shown in FIG. 3;

FIG. 6 is a cross-sectional view of the grill shown in FIG. 3;

FIG. 7 is another cross-sectional view of the grill shown in FIG. 6;

FIG. 8 is a cross-sectional view of the grill in another position than shown in FIG. 7;

FIG. 9 is a cross-sectional view of the grill in another position than shown in FIG. 6; and

FIG. 10 is a cross-sectional view of the grill in another position than shown in FIG. 9.

### DETAILED DESCRIPTION OF PREFERRED EMBODIMENT

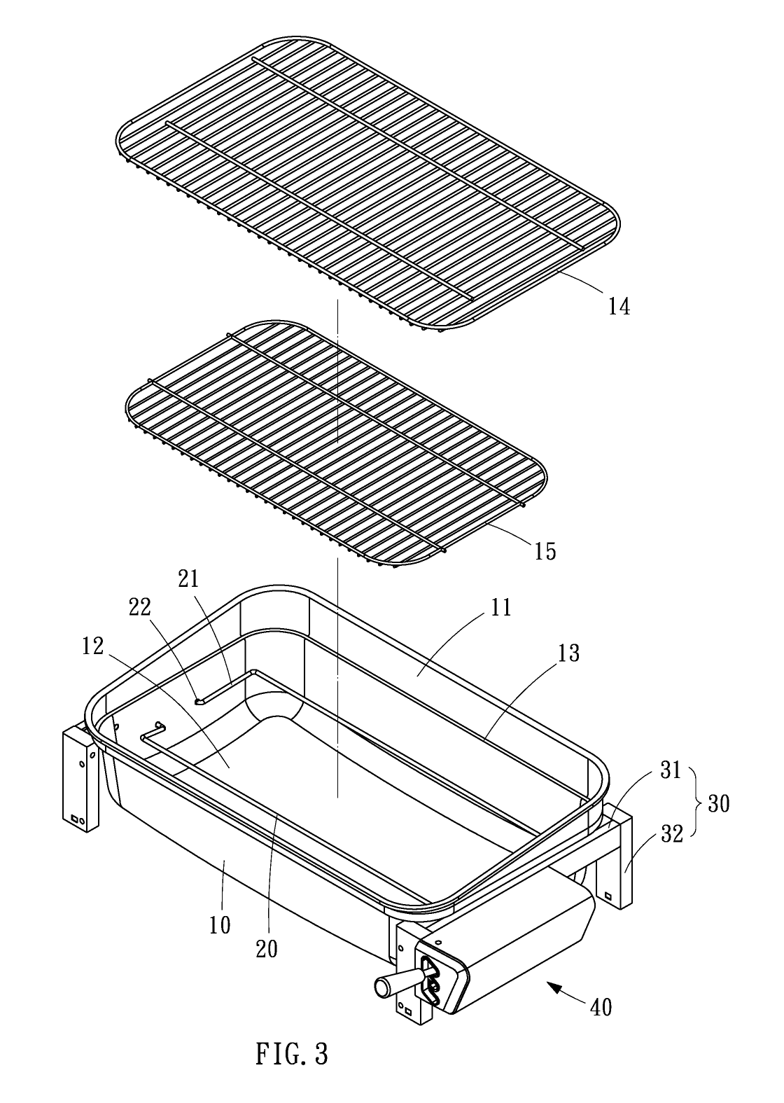

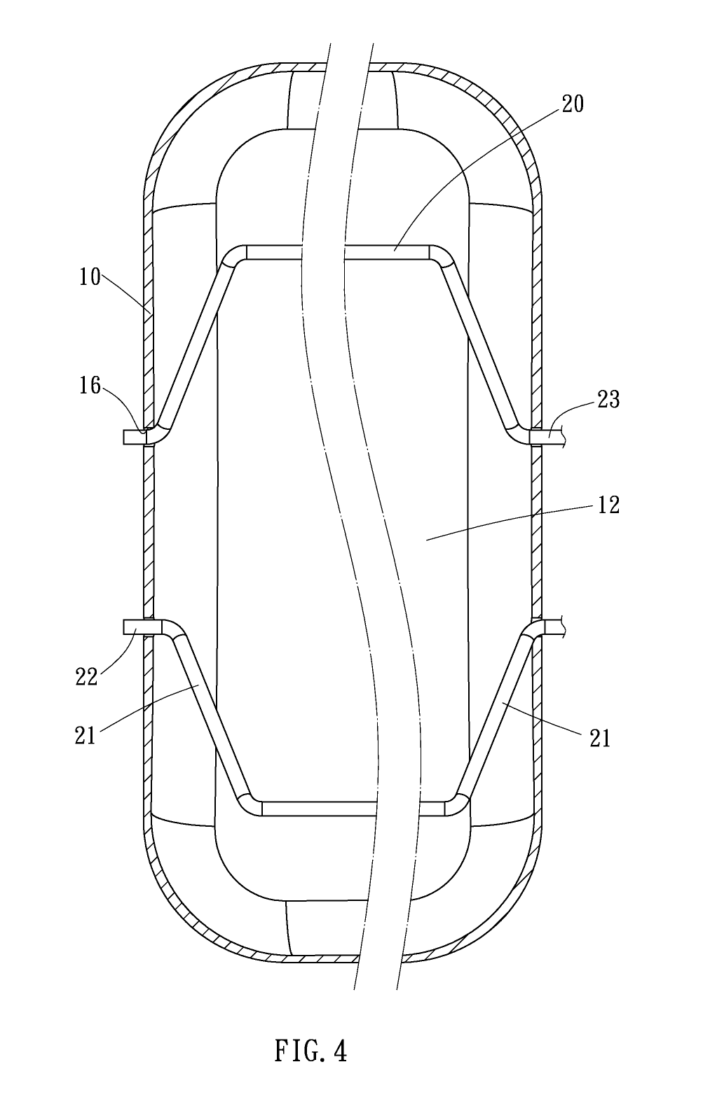

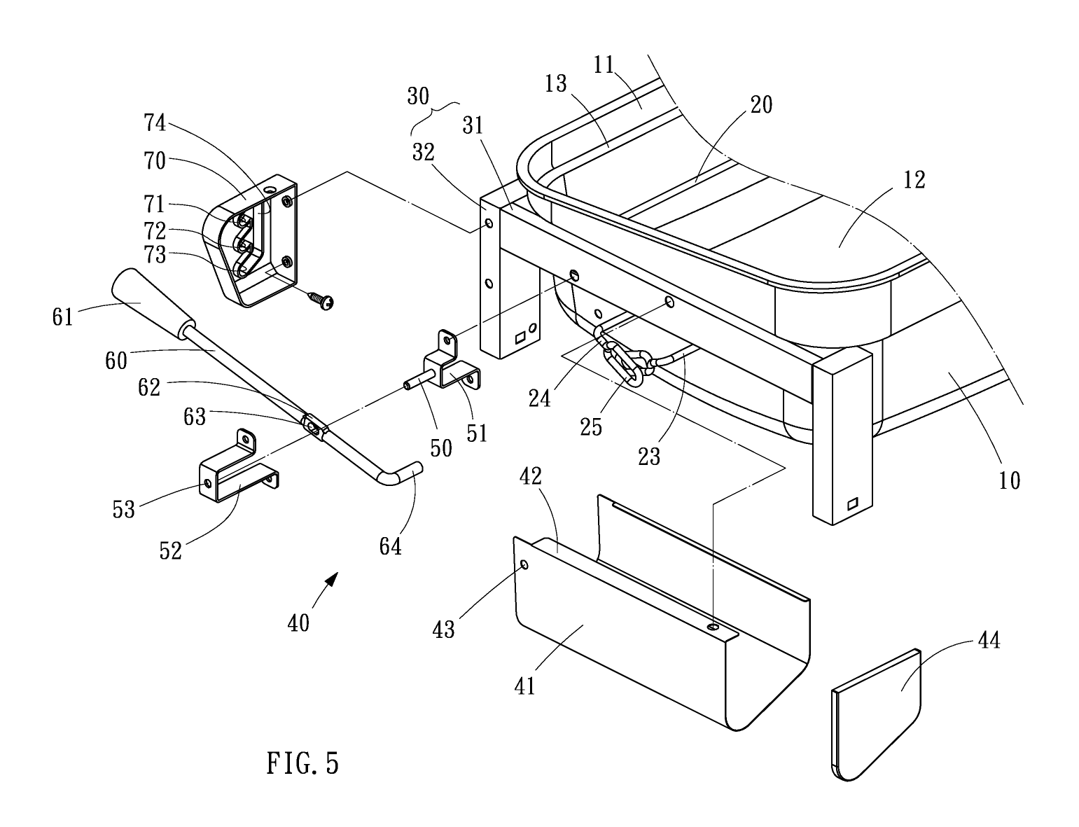

Referring to FIGS. 3 to 5, there is shown a grill according to the preferred embodiment of the present invention. The grill includes a fire pan 10, a first grid 14, a second grid 15 supported on the fire pan 10, and reliable, smooth means for adjusting the elevation of the second grid 15 relative to a fire pan 10. The fire pan 10 includes a wall 11 extending on and around a floor 12. The wall 11 includes a lower portion projecting from the floor 12, a larger upper portion and a shoulder 13 extending between the lower and upper sections. Two apertures 16 are defined in a lateral portion of the wall 11 while two other apertures 16 are defined in an opposite lateral portion of the wall 11.

The adjustment means includes two support members 20, a stand 30 and a control unit 40. Each of the support members 20 includes a middle section, first and second arms 21 each extending from the middle section at an angle, a first journal 22 extending from the first arm 21 at an angle, a second journal 23 extending from the second arm 21 at an angle, a crank 24 extending from the second journal 23 at an angle, and a loop 25 secured to the crank 24.

The stand 30 includes two beams 31 and four posts 32. Each of the beams 31 is connected to two relative ones of the posts 32. The stand 30 will not be further described in detail for not being the spirit of the present invention. It should however be noted that the fire pan 10 is supported on the stand 30 as the shoulder 13 is supported on the beams 31.

The control unit 40 includes a shell 41, a connector, a lever 60, a panel 70 and a back plate 44. The shell 41 is made with a bent edge 42 corresponding to one of the beams 31. An aperture 43 is defined in an upper portion of the shell 41. The shell 41 is made of a metal sheet by punching for example.

The connector includes a bracket 51 and a restraining element 52. The bracket 51 includes an axle 50 projecting from a curved strip. The restraining element 52 includes an aperture 53 defined in a curved strip corresponding to the axle 50.

The lever 60 includes a rectilinear end, a bent end 64, a grip 61 connected to the rectilinear end, a flat portion 62 formed thereon between the bent and rectilinear ends, and an aperture 63 defined in the flat portion 62. A section of the lever 60 between the rectilinear end and the aperture 63 is longer than another section of the lever 60 between the bent end 64 and the aperture 63.

The panel 70 includes a slot 74 and three recesses 71, 72 and 73 defined therein. The recesses 71, 72 and 73 are in communication with the slot 74. The panel 70 is made of a metal sheet by punching for example.

In assembly, an end of the curved strip of the bracket 51 is secured to the wall 11 of the fire pan 10 while another end of the curved strip of the bracket 51 is connected to one of the beams 31 located near the loops 25. The axle 50 is inserted through the aperture 63, thus pivotally connecting the lever 60 to the bracket 51. The axle 50 is further inserted through the aperture 53. An end of the curved strip of the restraining element 52 is secured to the wall 11 of the fire pan 10 while another end of the curved strip of the restraining element 52 is connected to the beam 31 located near the loops 25, thus keeping the pivotal connection of the lever 60 to the bracket 51. The bent end 64 of the lever 60 is inserted through the loops 25, thus operatively connecting the lever 60 to the support members 20.

The bent edge 42 of the shell 41 is secured to the beam 31 located near the loops 25, thus covering the connector, a portion of the lever 60 and the loops 25. The panel 70 is secured to the shell 41 by driving a screw in the aperture 43 through an aperture defined in the panel 70. It should be noted that the panel 70 is secured to the shell 41 after the lever 60 is inserted through the slot 74. The panel 70 extends parallel to the second journals 23 of the support members 20.

The second grid 15 is supported on the middle sections of the support members 20. The first grid 14 is supported on the shoulder 13 of the wall 11 of the fire pan 10. The first grid 14 is located above the second grid 15.

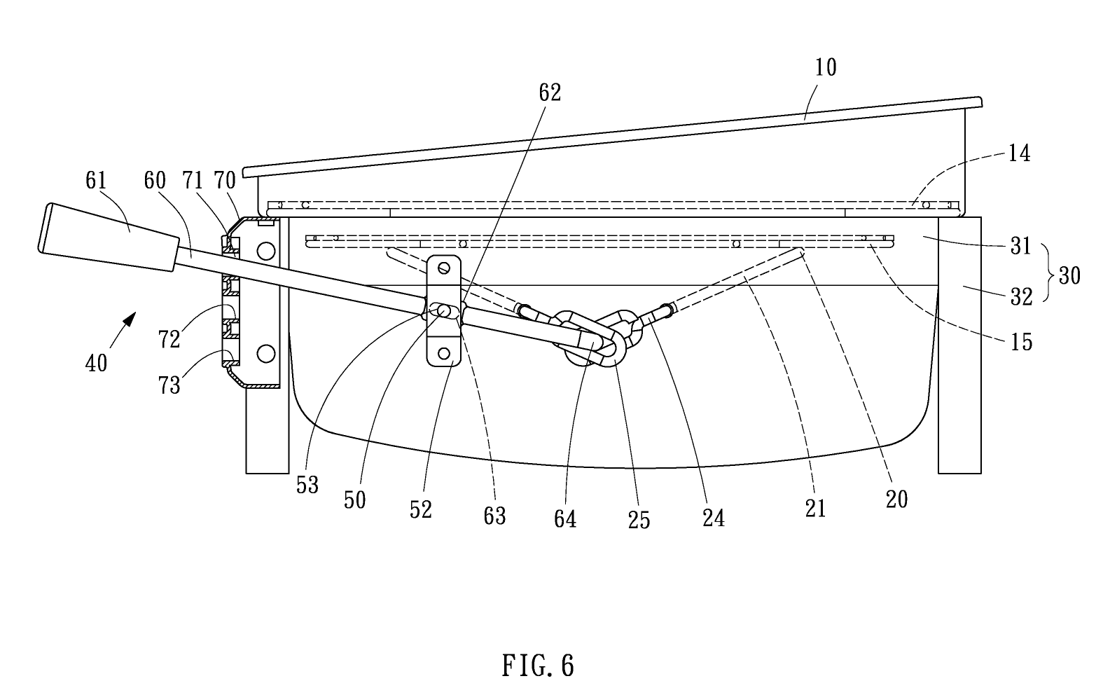

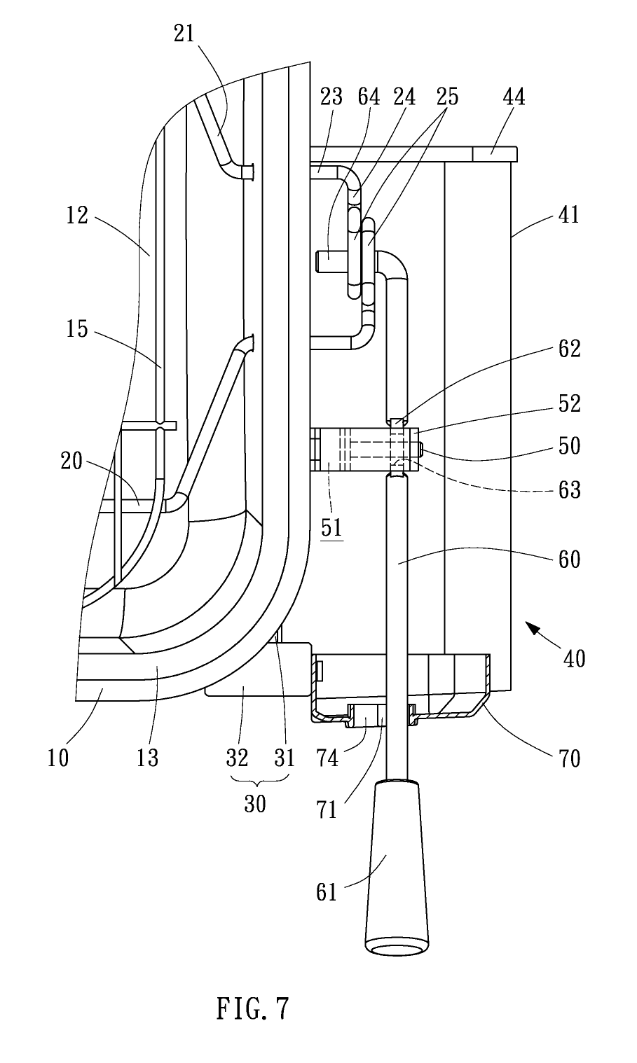

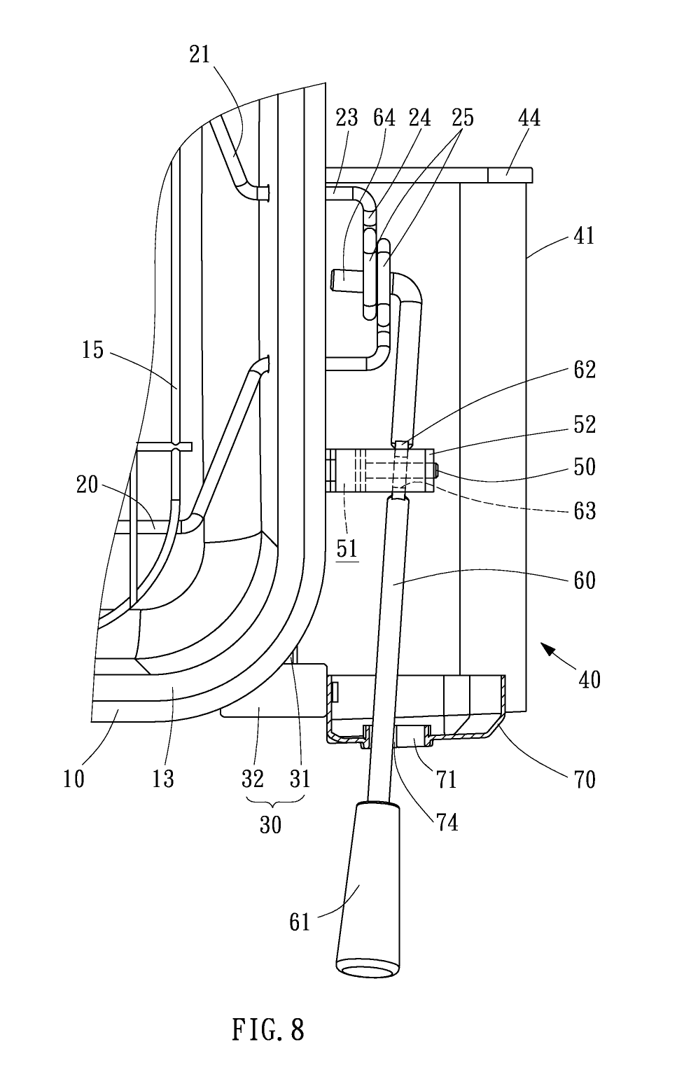

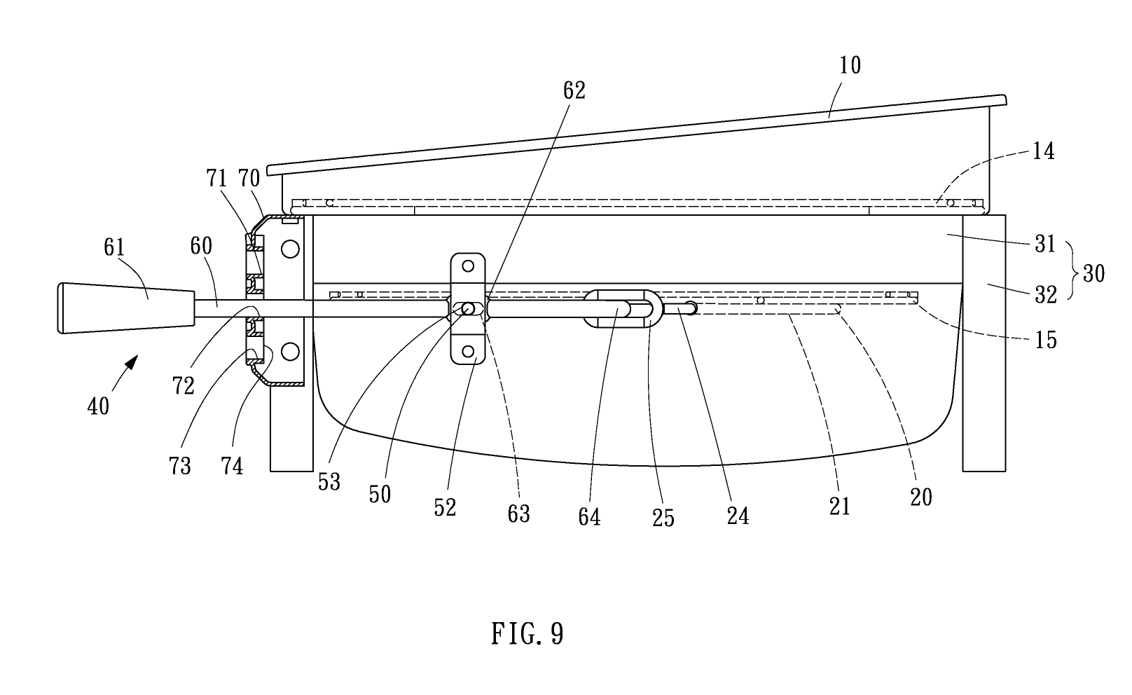

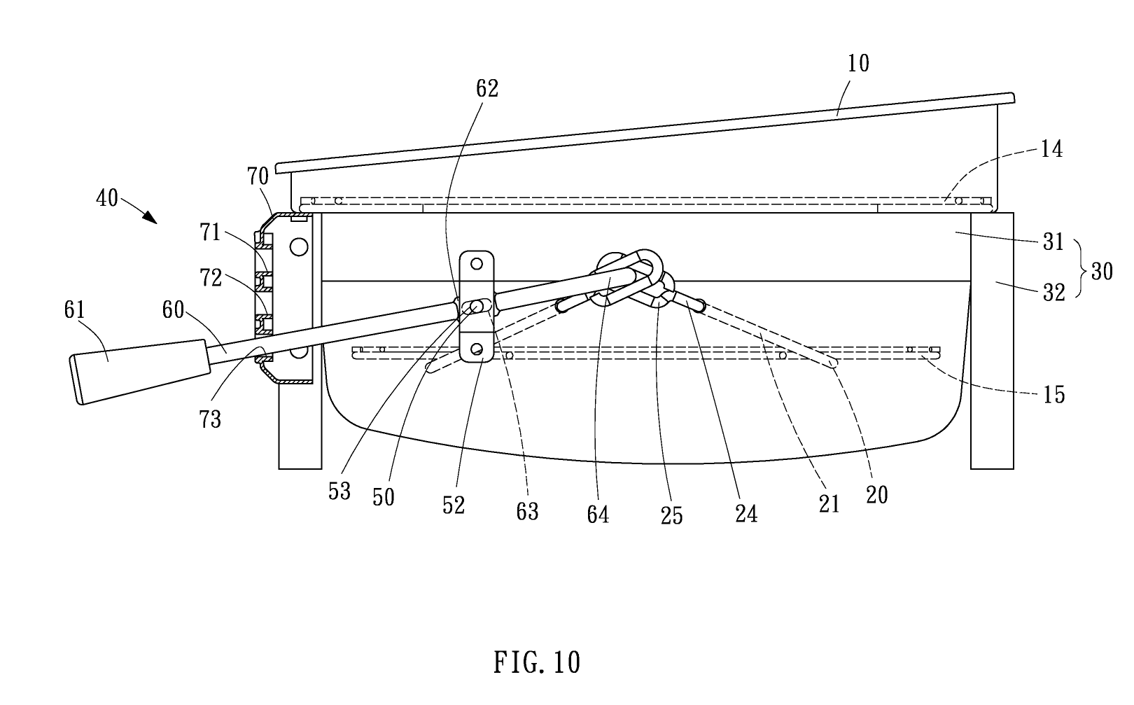

In use, food is located on the first grid 14 while fuel such as coal and wood is located on the second grid 15. The food can be cooked by heat released from the fuel in burning. By holding the grip 61 and pivoting the lever 60, the vertical positions of the middle sections of the support members 20 are adjusted synchronously as shown in FIGS. 6 to 10. That is, the elevation of the second grid 15 is adjusted while the second grid 15 is retained horizontal.

As the elevation of the second grid 15 is adjusted, the elevation of the first grid 14 is retained. Hence, the distance between the food and the fuel is adjusted. The lever 60 can be inserted into the first recess 71, the second recess 72 or the third recess 73 from the slot 74, thus retaining the second grid 15 in a selected one of three vertical positions.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A grill including:
a fire pan;
two support members each including a middle section, two arms extending from the middle section at an angle, two journals each extending from a related one of the arms at an angle, a crank extending from one of the journals at an angle, and a loop secured to the crank, wherein the journals are inserted through the fire pan;
a lever pivotally connected to the fire pan and formed with a bent end inserted through the loops of the support members and a rectilinear end maneuverable by a user to pivot the lever to adjust the elevation of the middle sections of the support members; and
a panel extending parallel to the journals of the support members and including a slot defined therein and recesses in communication with the slot, wherein the lever is inserted through and movable along the slot and can be inserted in a selected one of the recesses.

2. The grill according to claim 1, further including a connector for pivotally connecting the lever to the fire pan.

3. The grill according to claim 2, wherein the connector includes an axle connected to the fire pan and inserted through a portion of the lever between the bent and rectilinear ends.

4. The grill according to claim 3, wherein the connector includes a bracket connected to the fire pan, wherein the axle is connected to the bracket.

5. The grill according to claim 4, wherein the connector includes a restraining element connected to the fire pan and formed with an aperture through which the axle is inserted, thus the lever is kept between the restraining element and the bracket.

6. The grill according to claim 4, wherein the lever includes an aperture through which the axle is inserted.

7. The grill according to claim 1, further including a grip connected to the lever.

8. The grill according to claim 1, further including a shell for covering the loops of the support members and a portion of the lever.

9. The grill according to claim 8, wherein the panel is secured to an end of the shell.

10. The grill according to claim 9, further including a back plate connected to an opposite end of the shell.

11. The grill according to claim 1, further including a stand for supporting the fire pan.
